(19) United States
(12) Patent Application Publication
(10) Pub. No.: US 2012/0275850 A1
(43) Pub. Date: Nov. 1, 2012

(54) CLIP DEVICE AND CLIP DEVICE ASSEMBLY

(75) Inventor: CHIH-PENG LEE, Tu-Cheng (TW)

(73) Assignee: FOXCONN TECHNOLOGY CO., LTD., Tu-Cheng (TW)

(21) Appl. No.: 13/172,870

(22) Filed: Jun. 30, 2011

(30) Foreign Application Priority Data
Apr. 27, 2011 (TW) 100114636

(51) Int. Cl. F16B 5/02

(52) U.S. Cl. 403/299

(57) ABSTRACT

A clip device includes a clip module and a workpiece. The clip module includes a screw and a spring. The screw includes a screw head and a screw rod extends from the screw head. The spring includes a bent portion. The spring is placed around the screw rod, and the bent portion is away from the screw head. The workpiece includes a through hole corresponding to the screw rod and a receiving portion. The bent portion of the spring is engaged in the receiving portion. The screw rod extends through the through hole to fix the workpiece on a predetermined position.

### BACKGROUND

1. Technical Field

The present disclosure relates to clip devices and, more particularly, to a clip device for protecting an outer surface of a workpiece.

2. Description of Related Art

One kind of clip device generally includes a screw and a coil spring placed around the screw. The screw extends through a through hole of a workpiece to fix the workpiece on a predetermined position of another body, such as a circuit board or a housing of an electronic device. However, one end of the spring may deface an outer surface of the workpiece because of frequent use of the clip device.

Therefore, what is needed is a clip device which can overcome the above-described shortcomings.

### BRIEF DESCRIPTION OF THE DRAWINGS

FIG. 1 is an isometric view of a clip device in accordance with a first embodiment of the present disclosure, showing the clip device being attached to a workpiece.

FIG. 2 is a disassembled view of the clip device and workpiece of FIG. 1.

FIG. 3 shows an operational state of the clip device and workpiece of FIG. 1.

FIG. 4 is an isometric view of a clip device in accordance with a second embodiment of the present disclosure, showing the clip device being attached to a workpiece.

FIG. 5 is an isometric view of a clip device in accordance with a third embodiment of the present disclosure, showing the clip device being attached to a workpiece.

FIG. 6 is an isometric view of a clip device in accordance with a fourth embodiment of the present disclosure, showing the clip device being attached to a workpiece.

### DETAILED DESCRIPTION

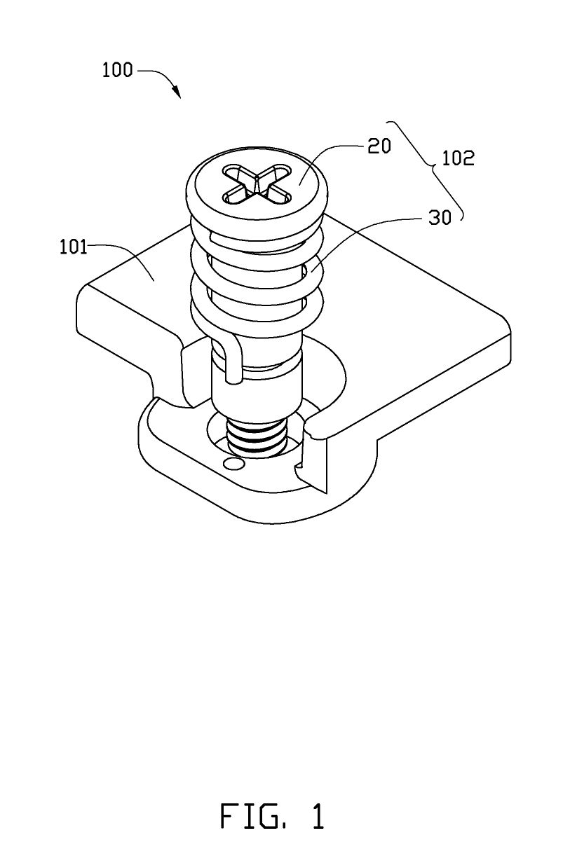

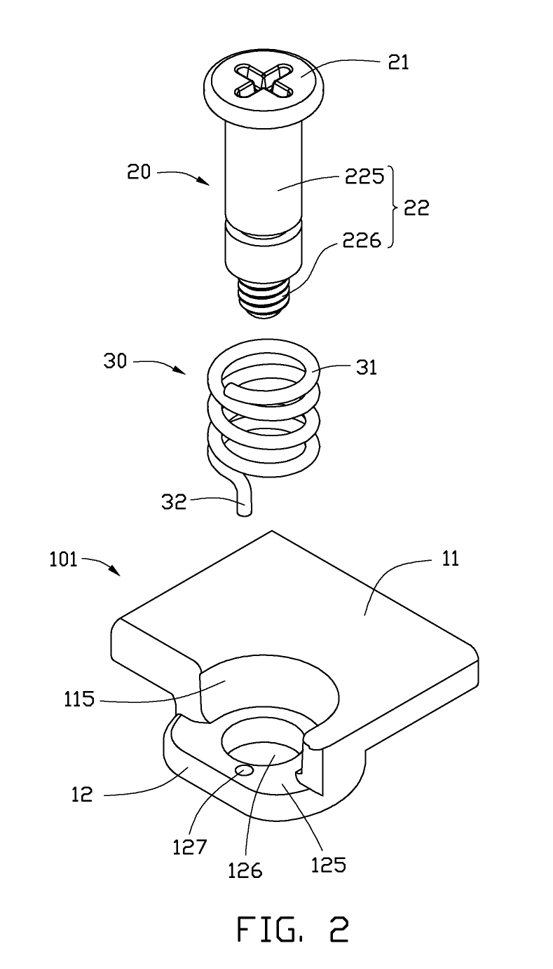

Referring to FIGS. 1 and 2, a first embodiment of a clip device assembly 100 is shown. The clip device assembly 100 includes a clip module 102 and a workpiece 101. The clip module 102 is configured to fix the workpiece 101 on a predetermined position of another body (not shown), such as a circuit board or a housing of an electronic device. The clip module 102 includes a screw 20 and a spring 30.

The screw 20 includes a screw head 21, and an elongated screw rod 22 extending from the screw head 21. The screw head 21 is disk-shaped. A cross-shaped groove is defined in a top surface of the screw head 21, for facilitating operation of the clip device assembly 100 by a tool such as a screwdriver. In alternative embodiments, the groove can be linear.

The screw rod 22 includes a cylindrical-shaped main body 225 connected to the screw head 21, and a screw thread 226 extending from the main body 225. In the present embodiment, the main body 225 perpendicularly extends from a center of the screw head 21. A diameter of the main body 225 is less than that of the screw head 21. The screw thread 226 extends from one end portion of the main body 225, and a diameter of the screw thread 226 is less than that of the screw head 21. In alternative embodiments, the diameter of the screw thread 226 can be equal to that of the screw head 21.

The spring 30 includes a spiral portion 31, and a bent portion 32 at a bottom end of the spiral portion 31. An inner diameter of the spiral portion 31 is larger than the diameter of the main body 225 of the screw rod 22, and an outer diameter of the spiral portion 31 is less than the diameter of the screw head 21. In the present embodiment, the spring 30 is essentially a cylindrical helical spring. The bent portion 32 of the spring 30 extends down from the bottom end of the spiral portion 31, and is parallel to an axis of the spiral portion 31. The spring 30 is placed around the screw rod 22 of the screw 20, and a top end of the spiral portion 31 abuts against the screw head 21 of the screw 20.

The workpiece 101 includes a body 11 and a fixture 12. In the present embodiment, the fixture 12 is arranged at a corner of and below the body 11. The body 11 includes an arc side surface 115, and the fixture 12 includes an upper surface 125. The side surface 115 of the body 11 and upper surface 125 of the fixture 12 cooperatively define a cavity. The fixture 12 defines a through hole 126 and a receiving portion 127 at the upper surface 125 thereof. The through hole 126 is cylindrical, for receiving the screw rod 22. A diameter of the through hole 126 is larger than that of the screw rod 22, and the diameter of the through hole 126 is less than that of the screw head 21. The receiving portion 127 comprises a cylindrical hole for receiving the bent portion 32 of the spring 30. In alternative embodiments, the receiving portion 127 can comprise a groove.

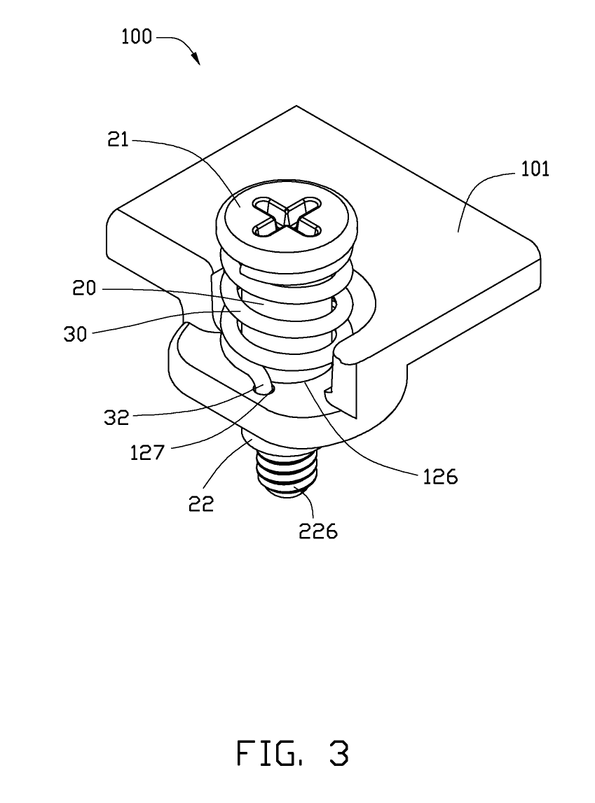

Referring to FIG. 3, in assembly of the workpiece 101 with the clip module 102, the spiral portion 31 of the spring 30 is placed around the screw rod 22 of the screw 20, and the bent portion 32 of the spring 30 extends into the receiving portion 127 of the workpiece 101. The screw rod 22 of the screw 20 extends through the through hole 126 to fix the workpiece 101 on a predetermined position of another body (not shown). As a result, the spring 30 is compressed. Because of the bent portion 32 engaged in the receiving portion 127, the outer surface of the workpiece 101 avoids being defaced by the bent portion 32 during and after assembly.

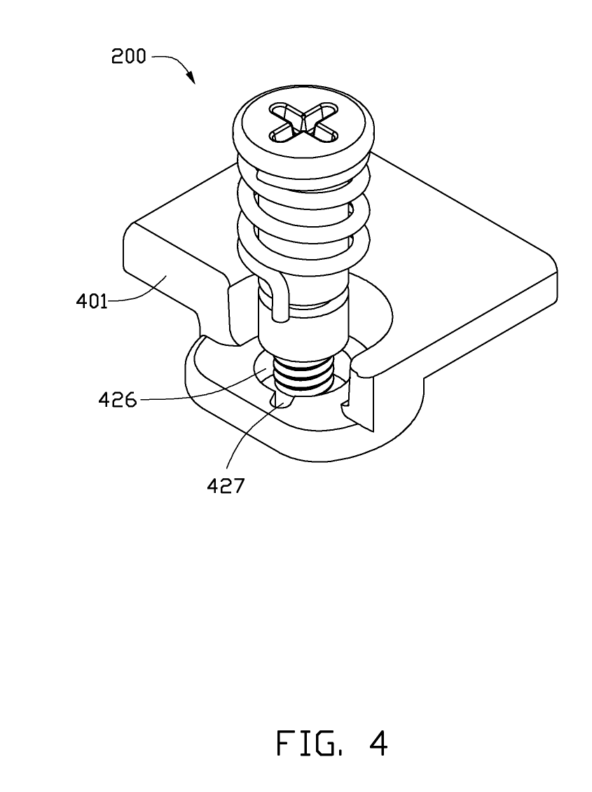

Referring to FIG. 4, a second embodiment of a clip device assembly 200 is shown. The clip device assembly 200 of the second embodiment is essentially the same as the clip device assembly 100 of the first embodiment, except for the following difference. In the second embodiment, the through hole 426 of the workpiece 401 communicates with the receiving portion 427 of the workpiece 401. The receiving portion 427 is thus generally U-shaped.

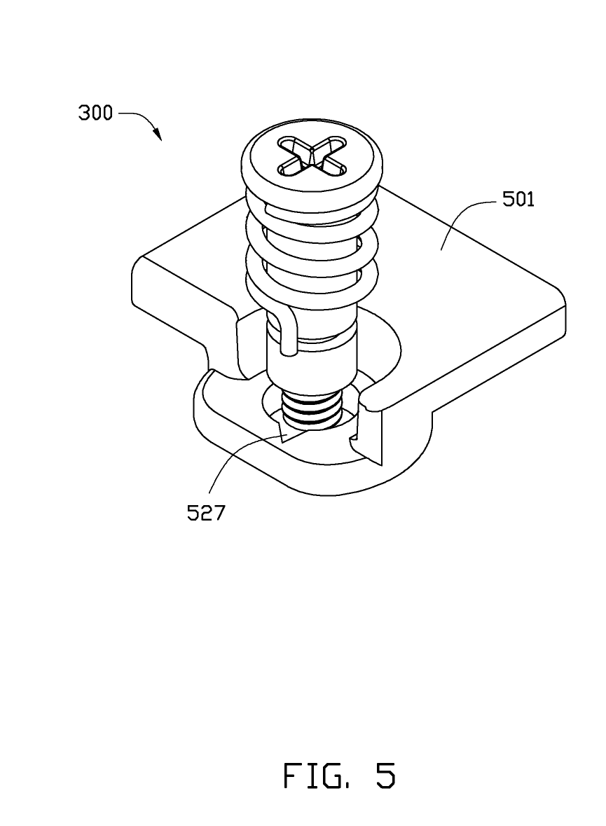

Referring to FIG. 5, a third embodiment of a clip device assembly 300 is shown. Different from the clip device assembly 200 of the second embodiment, a cross-section defined by the receiving portion 527 of the workpiece 501 is V-shaped.

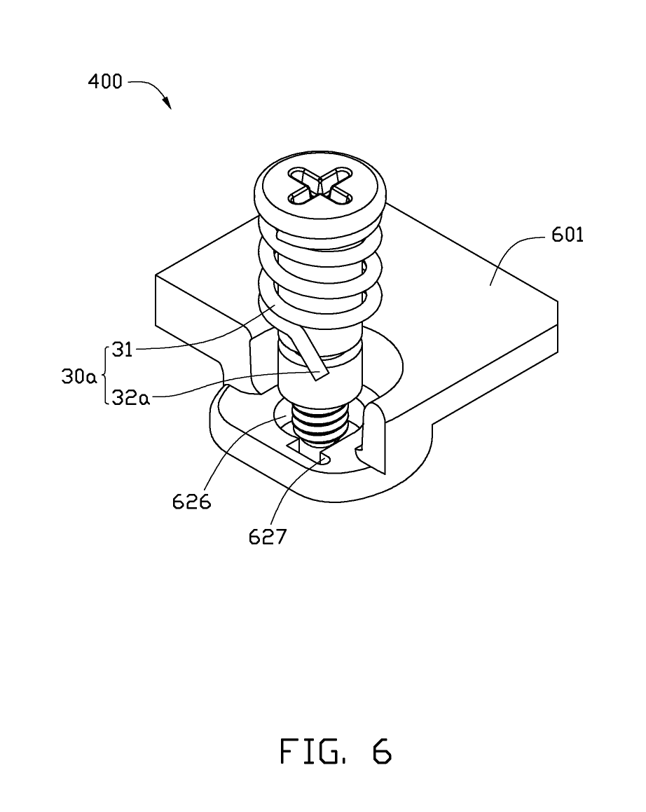

Referring to FIG. 6, a fourth embodiment of a clip device assembly 400 is shown. Different from the clip device assembly 100 of the first embodiment, the bent portion 32a of the spring 30a of the fourth embodiment is inclined to the axis of the spiral portion 31. A cross-section defined by the receiving portion 627 of the workpiece 601 is rectangular. The through hole 626 and the receiving portion 627 of the clip device assembly 400 are communicated with each other.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A clip device assembly comprising:
a clip module, the clip module comprising a screw and a spring, the screw comprising a screw head and a screw rod extending from the screw head, the spring comprising a bent portion at an end thereof, the spring being placed around the screw rod, and the bent portion being positioned away from the screw head; and
a workpiece, the workpiece comprising a through hole corresponding to the screw rod and a receiving portion, the bent portion of the spring being engaged in the receiving portion, the screw rod extendable through the through hole to fix the workpiece on a predetermined position of another body.

2. The clip device assembly of claim 1, wherein the spring is a cylindrical helical spring.

3. The clip device assembly of claim 2, wherein the cylindrical helical spring comprises a spiral portion, and the bent portion of the spring extends parallel to an axis of the spiral portion.

4. The clip device assembly of claim 2, wherein the cylindrical helical spring comprises a spiral portion, and the bent portion of the spring is inclined to an axis of the spiral portion.

5. The clip device assembly of claim 1, wherein the receiving portion of the workpiece comprises a hole.

6. The clip device assembly of claim 1, wherein the receiving portion and the through hole of the workpiece are communicated with each other.

7. The clip device assembly of claim 1, wherein a cross-section of the receiving portion taken parallel to the screw head is circular, rectangular, U-shaped, or V-shaped.

8. The clip device assembly of claim 1, wherein the screw rod comprises a main body connected to the screw head, and a screw thread extending from the main body.

9. A clip device for mounting a workpiece on a predetermined position of another body, the workpiece defining a through hole and a receiving hole adjacent to the through hole, the clip device comprising:
a screw comprising a head and a rod extending from the head, the rod extendable through the through hole of the workpiece; and
a spring coiled around the rod of the screw, the spring comprising a first end abutting the head of the screw and a second end away from the head, the second end bending at an angle such that the second end is engageable in the receiving hole of the workpiece.

10. The clip device of claim 9, wherein the second end of the spring extends along an axis direction of the spiral portion.

11. The clip device of claim 9, wherein the second end of the spring is inclined to the axis direction of the spiral portion.

12. The clip device of claim 9, wherein a cross-section view of the receiving hole is rectangle, U-shaped, or V-shaped.

13. A clip device assembly comprising:
a clip module, the clip module comprising a screw and a helical spring, the screw comprising a screw head and a screw rod extending from the screw head, the spring comprising a bent portion at an end thereof away from the screw head, the spring being placed around the screw rod; and
a workpiece, the workpiece comprising a through hole corresponding to the screw rod and a receiving portion communicated with the through hole, the bent portion of the spring being engaged in the receiving portion, the screw rod extendable through the through hole to fix the workpiece on a predetermined position of another body, the spring being compressed when the workpiece is fixed on the predetermined position of the other body.

14. The clip device assembly of claim 13, wherein a cross-section of the receiving portion taken parallel to the screw head is rectangular, U-shaped, or V-shaped.
